(19) United States
(12) Patent Application Publication
(10) Pub. No.: US 2014/0003445 A1
(43) Pub. Date: Jan. 2, 2014

(54) NETWORK APPLICATION VIRTUALIZATION METHOD AND SYSTEM

(71) Applicant: Electronics and Telecommunications Research Institute, Daejeon (KR)

(72) Inventors: Wang Bong LEE, Daejeon (KR); Joon Kyung LEE, Daejeon (KR); Dong Won KANG, Daejeon (KR); Jong Dae PARK, Daejeon (KR)

(21) Appl. No.: 13/933,680

(22) Filed: Jul. 2, 2013

(30) Foreign Application Priority Data
Jul. 2, 2012 (KR) 10-2012-0071965

(51) Int. Cl. H04L 12/927

(52) U.S. Cl. CPC H04L 47/803
USPC 370/412

(57) ABSTRACT

A method of virtualization of a network application in a network interface card is provided. The network application virtualization method includes: classifying an input packet; mapping the classified packet to a network application; creating a virtual port allocated to the network application; and switching the mapped packet to the virtual port.

### CROSS-REFERENCE TO RELATED APPLICATION

This application claims priority to and the benefit of Korean Patent

Application No. 10-2012-0071965 filed in the Korean Intellectual Property Office on Jul. 2, 2012, the entire contents of which are incorporated herein by reference.

### BACKGROUND OF THE INVENTION

(a) Field of the Invention

The present invention relates to a method and system of virtualization of a network application by processing a packet input from a network.

(b) Description of the Related Art With segmentation of the demand for IT technology, the existing general-purpose microprocessor is changing into a specialized structure in order to achieve better performance in a specific application. As the bandwidth of a network becomes increasingly higher, and the demand for applicability in operation increases, a dedicated network processor unit for processing such demands has emerged. A network processor unit (NPU) refers to a microprocessor that is optimized for packet processing in a network.

Virtualization refers to a technique for efficiently managing and controlling requests and interactions between computing resources, of which physical characteristics are abstracted, and objects such as users, applications, and computer systems.

At present, this virtualization technology is normally implemented in such a manner that an operating system installed in a general-purpose processor executes an application installed in the operating system.

To this end, a need arises for a technology for efficiently distributing network resources between network applications, a technology for transmitting a packet input into a processor to each application, and an application management technology, such as dynamic loading, for providing a service of a variety of network applications.

### SUMMARY OF THE INVENTION

The present invention has been made in an effort to provide a method which allows the use of a variety of applications by virtualization of a network application in a network device with a network processor or general-purpose processor mounted therein.

An exemplary embodiment of the present invention provides a method of virtualization of a network application in a network interface card. The network application virtualization method includes: classifying an input packet; mapping the classified packet to a network application; creating a virtual port allocated to the network application; and switching the mapped packet to the virtual port.

The classifying of an input packet may include classifying an input packet according to one or more of the following: a method of classification by Ethernet type, a method of classification by IP address, a method of classification by MAC (media access control) address of a packet, a method of classification by TCP port, and a method of classification by UDP port.

The mapping of the classified packet and a network application may include mapping the classified packet and a network application with reference to available resource information of a physical server where the network application is executed.

The switching of the mapped packet to the created virtual port may include: allocating the mapped packet to a queue; if the packet length is greater than a queue length for virtualization, discarding the packet; and if the packet length is less than the queue length for virtualization, switching the packet to the virtual port.

The network application virtualization method may further include storing the number of packets switched to the virtual port or the number of discarded packets.

Another embodiment of the present invention provides a network application virtualization system. The network application virtualization system includes: a traffic classifier for classifying an input packet according to a set classification method; an application manager for mapping the classified packet to a network application; a resource manager for managing resources of hardware where the network application is executed; and a virtual switch for switching the classified packet to the mapped network application based on hardware resource information.

The set classification method may include one or more of the following: a method of classification by Ethernet type, a method of classification by IP address, a method of classification by MAC (media access control) address of a packet, a method of classification by TCP port, and a method of classification by UDP port.

The application manager may store information on an executable network application.

The resource manager may provide statistics for a history of hardware resource use.

The network application virtualization system may further include a command interface for receiving a command for changing the set classification method.

The command interface may receive a command for updating the functions of the traffic classifier, application manager, and resource manager.

The virtual switch may include: a queue manager for managing a plurality of queues of the virtual switch and analyzing at least one of the queue for the classified packet; a scheduler for adjusting the transmission order of the classified packet; and a port manager for managing matching information of a virtual port allocated to the mapped network application and a hardware port.

According to an embodiment of the present invention, a network application is virtualized in a network device with a network processor or general-purpose processor mounted therein, whereby various types of packets can be transmitted to the network application, and resources of hardware where the network application is executed can be efficiently used.

### BRIEF DESCRIPTION OF THE DRAWINGS

FIG. 1 is a view showing a network application virtualization system according to an exemplary embodiment of the present invention.

FIG. 2 is a view showing an application virtualization adaptor according to an exemplary embodiment of the present invention.

FIG. 3 is a sequential chart showing a packet processing process in an application virtualization adaptor according to an exemplary embodiment of the present invention.

FIG. 4 shows a virtual switch according to an exemplary embodiment of the present invention.

FIG. 5 is a sequential chart showing a packet control process of a virtual switch according to an exemplary embodiment of the present invention.

FIG. 6 is a view showing an interface panel of a network application according to an exemplary embodiment of the present invention.

FIG. 7 is a view showing an example of application of a network application virtualization adaptor according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

Now, a network application virtualization method according to an exemplary embodiment of the present invention will be described in detail with reference to the drawings.

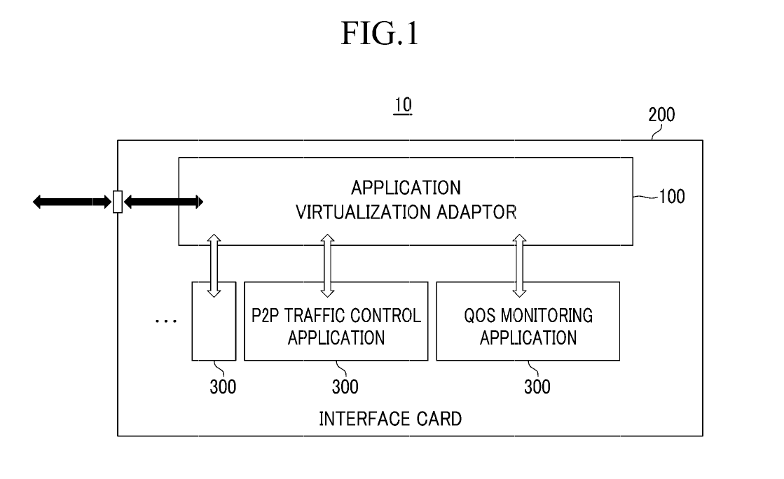

FIG. 1 is a view showing a network application virtualization system according to an exemplary embodiment of the present invention.

Referring to FIG. 1, the network application virtualization system 10 includes an application virtualization adaptor 100, an interface card 200, a network application 300, and a network interface 400. A peer-to-peer (hereinafter, ‘P2P’) traffic control application and a quality-of-service (hereinafter, ‘QoS’) application, which are shown in FIG. 1, are examples of network applications 300. The application virtualization adapter 100 processes a packet input via the network interface 400, and transmits the processed packet to the network application 300.

The application virtualization adaptor 100 may be implemented in a processor included in the interface card 200. The processor in which the application virtualization adaptor 100 is implemented may be a network processor or a general-purpose processor, but is not limited to a particular type of processor.

The interface card 200 includes a TCP/IP (transmission control protocol/internet protocol) socket, a PCI (peripheral component interface) bus, etc., and may be installed in network equipment such as a router.

The network application 300 is executed according to a user's intention of processing a packet input into the interface card 200. The network application 300 is executed after being loaded onto the interface card 200.

In the case that the network application virtualization system 10 according to an exemplary embodiment of the present invention is connected to a GENI (global environment for network innovations) future internet test network, the network application 300 may be an application for processing a packet for GENI, or may be a variety of types of applications depending on the purpose of packet processing.

The network interface 400 is one of the interfaces included in the interface card 200, and transmits a packet to the application virtualization adaptor 100. Various types of packets may be input into the network interface 400 depending on a network environment where the interface card 200 is installed. In the case that the network interface 400 is an Ethernet 1 G, 10G, or 100G interface, an IP (internet protocol) packet and a non-IP packet may be input into the system 10.

The arrows shown in FIG. 1 indicate paths of a packet. A path of a packet input or output into/from the system 10 according to the present invention is indicated by a black arrow, and a path of a packet sent and received between the application virtualization adaptor 100 and the network application 300 is indicated by a white arrow.

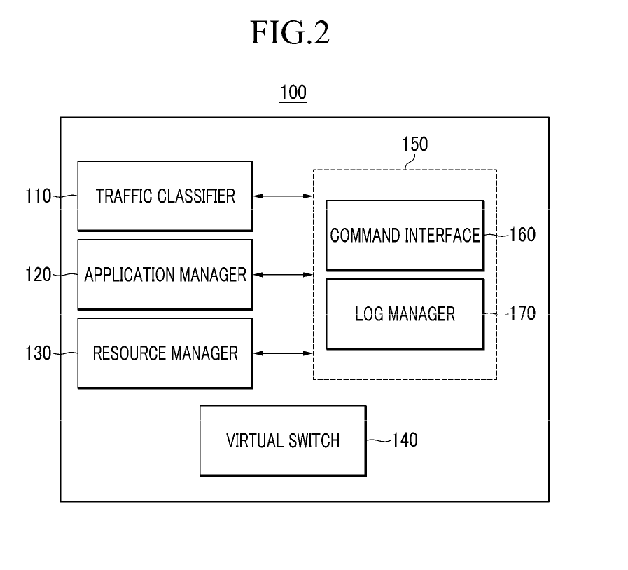

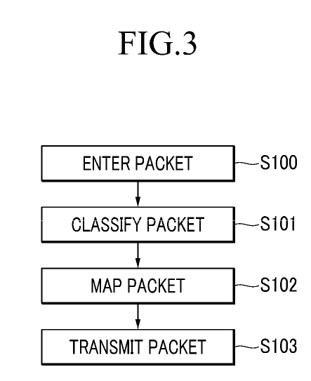

Hereinafter, a process for processing a packet into the interface card 200 by the application virtualization adaptor 100 and transmitting it to the network application 300 will be described with reference to FIGS. 2 and 3. FIG. 2 is a view showing an application virtualization adaptor according to an exemplary embodiment of the present invention, and FIG. 3 is a sequential chart showing a packet processing process in an application virtualization adaptor according to an exemplary embodiment of the present invention.

Referring to FIG. 2, the application virtualization adaptor 100 includes a traffic classifier 110, an application manager 120, a resource manager 130, a virtual switch 140, and a controller 150.

The traffic classifier 110 classifies various types of packets input into the network interface 400.

The application manager 120 maps a packet classified by the traffic classifier 110 to a corresponding network application 300.

The resource manager 130 provides information on various types of available resources of hardware, such as an actual physical server, where a network application is executed.

With reference to the information on various types of available resources, the virtual switch 140 transmits the packet mapped to the network application 300 to the network application 300, or transmits the packet transmitted from the network application 300 to the outside of the interface card 200.

The controller 150 includes a command interface 160 and a log manager 170.

Via the command interface 160, the user enters a packet classification method of the traffic classifier 110 and a command for updating the functions of the traffic classifier 110, application manager 120, and resource manager 130.

The log manager 170 stores a packet classification method, a command execution result, or error information which is input via the command interface 160.

Referring to FIG. 3, the packet processing process of the application virtualization adaptor 100 shown in FIG. 2 will be described. First, a packet input into the application virtualization adaptor 100 via the network interface 400 is classified by the traffic classifier 110 (S101).

Packet classification methods to be applicable herein include a method of classification by Ethernet type, a method of classification by IP address, a method of classification by MAC (media access control) address of a packet, a method of classification by TCP port, and a method of classification by UDP port.

As described above, these packet classification methods can be updated by the user entering a text command in the traffic classifier 110 via the command interface 160.

Then, the application manager 120 maps a packet classified by the traffic classifier 110 to a corresponding network application 300 (S102).

The application manager 120 stores information on the network application 300 to be mapped.

When an executable network application 300 is registered to the application manager 120, the application manager 120 creates a virtual port allocated to the network application 300, and stores information on the created virtual port.

Also, the application manager 120 stores a lot of information (resource information, application execution time, etc.) which is to be used to control the network application 300.

In the step S102 for mapping the classified packet, current available information on hardware, such as an actual physical server, for executing the network application 300 is taken into consideration. Hereupon, the resource manager 130 checks for available resource information of hardware in real time and provides it to the application manager 120, thereby allowing the operation of the network application 300 to be properly performed. Moreover, the resource manager 130 calculates statistics for a history of hardware resource use.

Specific hardware may have free access to processor resources, but also such access may be very limited because the aforementioned function of the resource manager 130 is much dependent on a HAL (hardware abstract layer) interface provided by the processor of the interface card 200.

Thereafter, the virtual switch 140 transmits the mapped packet to the network application 300 (S103).

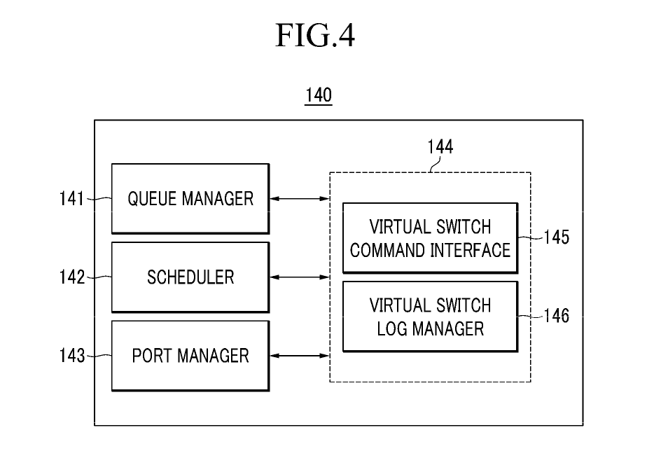

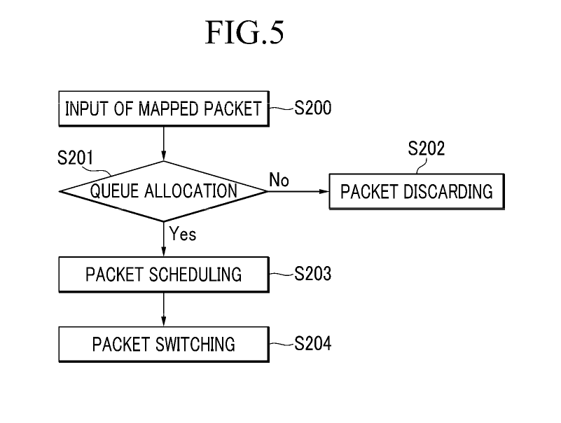

A method for the virtual switch 140 to control the mapped packet and transmit it to the network application 300 will be described in detail with reference to FIGS. 4 and 5.

FIG. 4 is a view showing a virtual switch according to an exemplary embodiment of the present invention, and FIG. 5 is a sequential chart showing a packet control process of a virtual switch according to an exemplary embodiment of the present invention.

Referring to FIG. 4, the virtual switch 140 includes a queue manager 141, a scheduler 142, a port manager 143, and a controller 144.

The queue manager 141 manages a queue of the virtual switch 140 to transmit a packet to the network application 130. The scheduler 142 adjusts the transmission order of the packet.

The port manager 143 manages matching information of a virtual port and a hardware port included in the interface card 200.

The controller 144 includes a virtual switch command interface 145 and a virtual switch log manager 146. The virtual switch command interface 145 receives a command for updating the functions of the queue manager 141, the scheduler 142, and the port manager 143 included in the virtual switch 140. The virtual switch log manager 146 stores a command execution result, which is executed through the virtual switch command interface 145, and error information about the command.

By using various algorithms such as a weighted fair queuing (WFQ) scheduling algorithm, the virtual switch 140 determines the length of a queue and implements packet transmission scheduling.

The virtual switch command interface 145 receives a text-based command, and transmits the command to the queue manager 141, the scheduler 142, or the port manager 143. A command execution result and error information are stored in the virtual switch log manager 146.

Referring to FIG. 5, a packet control process of the virtual switch 140 will be described. First, a packet mapped to a specific network application 300 from the application manager 120 is input into the virtual switch 140 (S200). Then, the queue manager 141 inserts the packet into a queue (S201).

By comparing the queue length and the packet length, it is determined whether the queue can be used. The queue is connected to the specific network application 300.

If the queue is full or the input packet is longer than the queue, the queue manager 141 discards the packet (S202). If the queue can be used because the length of the mapped packet is less than the queue length, the scheduler 142 adjusts the transmission order of the packet (S203).

Then, the queue manager 141 switches the packet inserted into the queue to the virtual port allocated to the network application 300 (S204).

Hereupon, the port manager 143 manages matching information of the virtual port and the hardware port so that the packet switched to the virtual port reaches the network application 300.

The number of switched packets and the number of discarded packets may be stored in the virtual switch log manager 146 for statistical work.

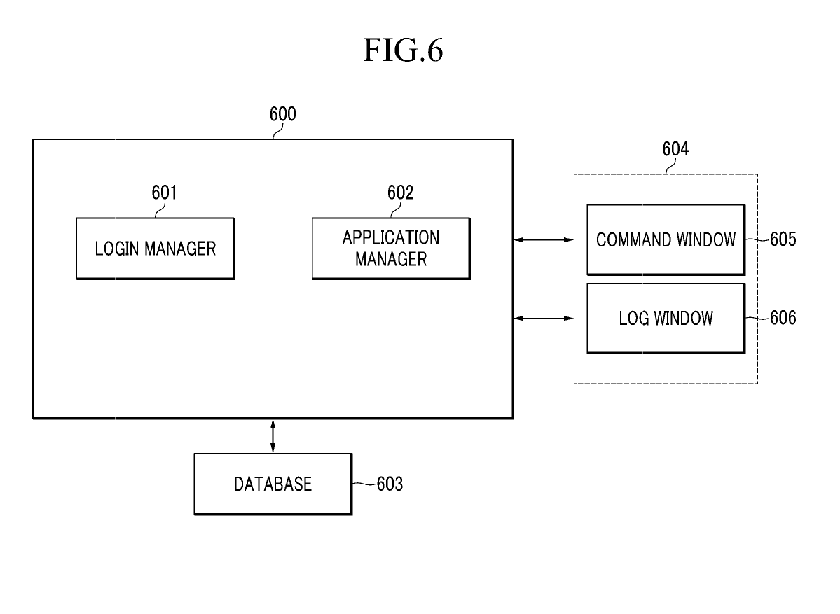

FIG. 6 is a view showing an interface panel of a network application according to an exemplary embodiment of the present invention.

Referring to FIG. 6, the interface panel 600 of the network application includes a login manager 601 and an application manager 602, and works in conjunction with a database 603 and an interface panel controller 604.

If the user makes a request for execution of a specific network application 300, a packet classified by the application virtualization adaptor 100 reaches the specific network application 300, and the user interfaces with the interface panel 600 and executes the specific network application 300. The interface panel 600 may be various types of internet browser depending on the user's operating system.

The login manager 601 checks whether the user is given access to the network application 300, in conjunction with the database 603.

Being connected to the network application 300 through the login manager 601, the user manages profile information, attribute information, connection information, or the like of the network application 300 by using the application manager 602, in conjunction with the database 603.

The interface panel controller 604 includes a command window 605 and a log window 606.

The user manages the interface panel 600 by entering a text-based command through the command window 605, and a command execution result and error information are stored in the log window 606.

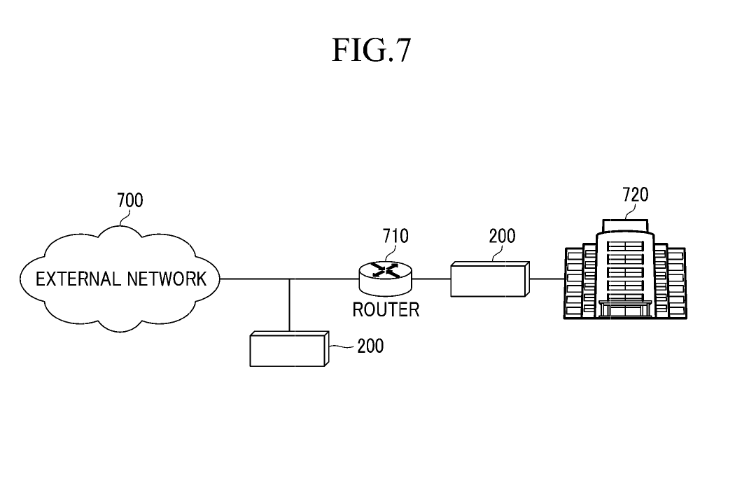

FIG. 7 is a view showing an example of application of a network application virtualization adaptor according to an exemplary embodiment of the present invention.

Referring to FIG. 7, the application virtualization adaptor 100 may be installed by being connected to the front or back of a router 710.

In this case, a connection may be established by an in-line method or a tapping method. Although FIG. 7 only illustrates connections established by these two methods, it is not necessary to use a plurality of methods at a time, and more than one method may be selected as required by a network.

When a system implementing a network application virtualization method according to an exemplary embodiment of the present invention is connected as such, a packet transmitted from an external network 700 is classified according to various criteria, and is properly transmitted to a network application 300 of a server 720.

According to an exemplary embodiment of the present invention, a network application is mounted in an on-the-fly fashion to a network application virtualization system, and therefore the user can use this system for real time software upgrades. That is, a network application 300 loaded onto a processor is used to process a packet input from an external network, and at the same time an upgrade version of the network application 300 is dynamically loaded. Therefore, a packet processing operation of the network application 300 can be maintained when upgrading software.

According to another exemplary embodiment of the present invention, an IP packet forwarding module is implemented as a network application virtualization system, and is therefore used as a device for performing the general functions of a router. An IP packet parsing function, a routing lookup function, a packet modification function, and a packet forwarding function are loaded onto the processor of the interface card 200, forwarding information is generated by a routing protocol stored in a control server, and the generated forwarding information is downloaded from the control server and used for forwarding lookup.

According to another exemplary embodiment of the present invention, a network application virtualization system is used as a network device for forwarding packets, a DPI (deep packet inspection) device for real-time packet analysis, a network device requiring dynamic loading of a program, and a firewall device for analyzing and blocking packets. The virtualization system according to the exemplary embodiment of the present invention can be used as the above-mentioned devices by the use of the sandbox functionality of a network application.

According to another exemplary embodiment of the present invention, a network application virtualization system can also be used as a network device for processing experimental packets for test service use or educational use, as is the case in which the system is connected to a GENI future internet test network.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of virtualization of a network application in a network interface card, comprising:
classifying an input packet;
mapping the classified packet to a network application;
creating a virtual port allocated to the network application; and
switching the mapped packet to the virtual port.

2. The method of claim 1, wherein the classifying of an input packet comprises classifying an input packet according to one or more of the following:
a method of classification by Ethernet type, a method of classification by IP address, a method of classification by MAC (media access control) address of a packet, a method of classification by TCP port, and a method of classification by UDP port.

3. The method of claim 1, wherein the mapping of the classified packet and a network application comprises mapping the classified packet and a network application with reference to available resource information of a physical server where the network application is executed.

4. The method of claim 1, wherein the switching of the mapped packet to the created virtual port comprises:
allocating the mapped packet to a queue;
if the packet length is greater than a queue length for virtualization, discarding the packet; and
if the packet length is less than the queue length for virtualization, switching the packet to the virtual port.

5. The method of claim 4, further comprising storing the number of packets switched to the virtual port or the number of discarded packets.

6. A network application virtualization system comprising:
a traffic classifier for classifying an input packet according to a set classification method;
an application manager for mapping the classified packet to a network application;
a resource manager for managing resources of hardware where the network application is executed; and
a virtual switch for switching the classified packet to the mapped network application based on hardware resource information.

7. The system of claim 6, wherein the set classification method comprises one or more of the following: a method of classification by Ethernet type, a method of classification by IP address, a method of classification by MAC (media access control) address of a packet, a method of classification by TCP port, and a method of classification by UDP port.

8. The system of claim 6, wherein the application manager stores information on an executable network application.

9. The system of claim 6, wherein the resource manager provides statistics for a history of hardware resource use.

10. The system of claim 6, further comprising a command interface for receiving a command for changing the set classification method.

11. The system of claim 10, wherein the command interface receives a command for updating the functions of the traffic classifier, application manager, and resource manager.

12. The system of claim 6, wherein the virtual switch comprises:
a queue manager for managing a plurality of queues included in the virtual switch and analyzing at least one of the queue for the classified packet;
a scheduler for adjusting the transmission order of the classified packet; and
a port manager for managing matching information of a virtual port allocated to the mapped network application and a hardware port.
